(19) United States
(12) Patent Application Publication
(10) Pub. No.: US 2023/0306957 A1
(43) Pub. Date: Sep. 28, 2023

(54) INFORMATION PROCESSING DEVICE AND INFORMATION PROCESSING METHOD

(71) Applicant: Sony Group Corporation, Tokyo (JP)

(72) Inventors: Hiro IWASE, Tokyo (JP); Yuhei TAKI, Tokyo (JP); Kunihito SAWAI, Tokyo (JP); Mari SAITO, Tokyo (JP); Ikuo YAMANO, Tokyo (JP)

(73) Assignee: Sony Group Corporation, Tokyo (JP)

(21) Appl. No.: 18/044,085

(22) PCT Filed: Sep. 22, 2021
(86) PCT No.: PCT/JP2021/034724

§ 371 Date: Mar. 6, 2023

(30) Foreign Application Priority Data
Oct. 1, 2020 (JP) 2020-167140

(51) Int. Cl. G10L 13/08; G10L 13/04; G10L 15/00

(52) U.S. Cl. CPC G10L 13/086; G10L 13/04; G10L 15/005

(57) ABSTRACT

In a terminal device (10), a communication unit (15) receives a counterpart utterance text in a counterpart language section and a counterpart utterance speech in a counterpart non-language section, and a control unit (11) outputs the counterpart utterance text after performing language translation, and outputs the counterpart utterance speech in the counterpart non-language section without performing language translation. For example, the control unit (11) outputs the counterpart utterance speech in the counterpart non-language section before outputting a result of the language translation of the counterpart utterance text.

### FIELD

The present disclosure relates to an information processing device and an information processing method.

### BACKGROUND

With the spread of telework, there is an increasing demand for a technology for smoothly performing remote communication using voice. There is a technology in which an utterance content of a speaker side is translated into a native language of a listener side and output to the listener side in a case where remote communication using voice is performed with different languages.

### CITATION LIST

### Patent Literature

Patent Literature 1: JP 2017-525167 A

### SUMMARY

### Technical Problem

The utterance content of the speaker side includes language information and non-language information such as a quick response and a filler. However, the non-language information in the utterance content is not a target of translation. For this reason, in a case where remote communication using voice is performed with different languages, nuances of speech, intention, attitude, emotions, and the like of the speaker side may not be conveyed to the listener side, and thus smooth remote communication between different languages has been hindered.

Therefore, the present disclosure proposes a technology that enables smooth remote communication between different languages.

### Solution to Problem

An information processing device in the present disclosure includes a communication unit and a control unit. The communication unit receives language information in a conversation with a communication counterpart and non-language information in the conversation. The control unit outputs the language information after performing language translation and outputs the non-language information without performing language translation.

### BRIEF DESCRIPTION OF DRAWINGS

FIG. 1 is a diagram illustrating a configuration example of a remote communication system according to a first embodiment of the present disclosure.

FIG. 2 is a diagram illustrating a configuration example of a terminal device according to the first embodiment of the present disclosure.

FIG. 3 is a flowchart illustrating an example of a processing procedure in the terminal device according to the first embodiment of the present disclosure.

FIG. 4 is a flowchart illustrating an example of a processing procedure in the terminal device according to the first embodiment of the present disclosure.

FIG. 5 is a flowchart illustrating an example of a processing procedure in the terminal device according to the first embodiment of the present disclosure.

FIG. 6 is a flowchart illustrating an example of a processing procedure in the terminal device according to the first embodiment of the present disclosure.

FIG. 7 is a flowchart illustrating an example of a processing procedure in the terminal device according to the first embodiment of the present disclosure.

FIG. 8 is a diagram for explaining an operation example of the remote communication system according to the first embodiment of the present disclosure.

FIG. 9 is a diagram for explaining an operation example of the remote communication system according to the first embodiment of the present disclosure.

FIG. 10 is a diagram for explaining an operation example of the remote communication system according to the first embodiment of the present disclosure.

FIG. 11 is a diagram for explaining an operation example of the remote communication system according to the first embodiment of the present disclosure.

FIG. 12 is a diagram for explaining an operation example of the remote communication system according to the first embodiment of the present disclosure.

FIG. 13 is a diagram for explaining an operation example of the remote communication system according to the first embodiment of the present disclosure.

FIG. 14 is a diagram for explaining an operation example of the remote communication system according to the first embodiment of the present disclosure.

FIG. 15 is a diagram for explaining an operation example of the remote communication system according to the first embodiment of the present disclosure.

### DESCRIPTION OF EMBODIMENTS

Hereinafter, embodiments of the present disclosure will be described with reference to the drawings. In the following embodiments, the same parts or the same processing are denoted by the same reference signs, and an overlapping description may be omitted.

In addition, the technology of the present disclosure will be described in the following order.

[First Embodiment]

<Configuration of Remote Communication System>

<Configuration of Terminal Device>

<Processing Procedure in Terminal Device>

<Operation of Remote Communication System>

<Operation Example 1>

<Operation Example 2>

<Operation Example 3>

<Operation Example 4>

<Operation Example 5>

<Operation Example 6>

<Operation Example 7>

<Operation Example 8>

[Second Embodiment]

<Modification>

[Third Embodiment]

[Effects of Disclosed Technology]

### First Embodiment

<Configuration of Remote Communication System>

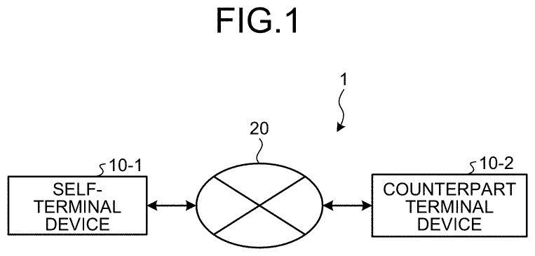

FIG. 1 is a diagram illustrating a configuration example of a remote communication system according to a first embodiment of the present disclosure. In FIG. 1, a remote communication system 1 includes a self-terminal device 10-1, a counterpart terminal device 10-2, and a network 20. The self-terminal device 10-1 and the counterpart terminal device 10-2 are connected via the network 20 and can communicate with each other. Examples of the self-terminal device 10-1 and the counterpart terminal device 10-2 include a personal computer and a smart device such as a smartphone or a tablet terminal. Examples of the network 20 include the Internet. Hereinafter, the self-terminal device 10-1 and the counterpart terminal device 10-2 may be collectively referred to as a “terminal device 10”.

<Configuration of Terminal Device>

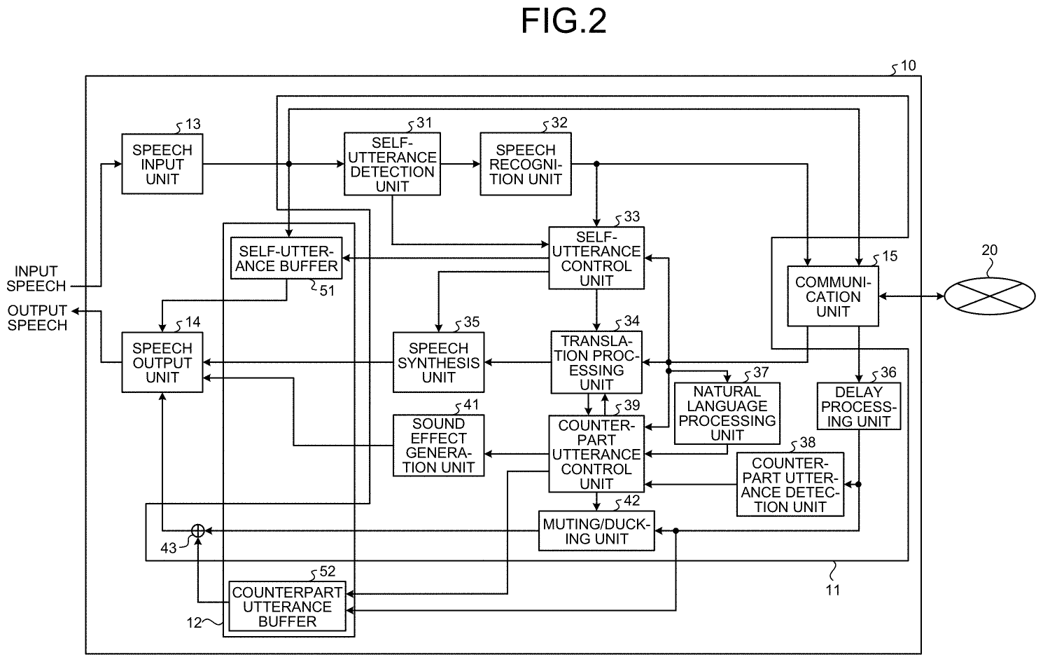

FIG. 2 is a diagram illustrating a configuration example of the terminal device according to the first embodiment of the present disclosure. The configuration example illustrated in FIG. 2 corresponds to configuration examples of both the self-terminal device 10-1 and the counterpart terminal device 10-2. That is, the self-terminal device 10-1 and the counterpart terminal device 10-2 adopt the same configuration. Furthermore, the self-terminal device 10-1 and the counterpart terminal device 10-2 are examples of an “information processing device”.

In FIG. 2, the terminal device 10 includes a control unit 11, a storage unit 12, a speech input unit 13, a speech output unit 14, and a communication unit 15. The control unit 11 includes a self-utterance detection unit 31, a speech recognition unit 32, a self-utterance control unit 33, a translation processing unit 34, a speech synthesis unit 35, a delay processing unit 36, a natural language processing unit 37, a counterpart utterance detection unit 38, a counterpart utterance control unit 39, a sound effect generation unit 41, a muting/ducking unit 42, and a counterpart utterance synthesis unit 43. The storage unit 12 includes a self-utterance buffer 51 and a counterpart utterance buffer 52. The communication unit 15 of the self-terminal device 10-1 and the communication unit 15 of the counterpart terminal device 10-2 communicate with each other via the network 20.

The control unit 11 is implemented by, for example, a processor as hardware. Examples of the processor that implements the control unit 11 include a central processing unit (CPU), a digital signal processor (DSP), a field programmable gate array (FPGA), and the like. Furthermore, the storage unit 12 is implemented by, for example, a storage medium as hardware. Examples of the storage medium for implementing the storage unit 12 include a memory, a hard disk drive (HDD), a solid state drive (SSD), and the like, and examples of the memory include a random access memory (RAM), a synchronous dynamic random access memory (SDRAM), a flash memory, and the like. Furthermore, the speech input unit 13 is implemented by, for example, a microphone as hardware. Furthermore, the speech output unit 14 is implemented by, for example, a speaker, a headphone, or an earphone as hardware. Furthermore, the communication unit 15 is implemented by, for example, a communication module as hardware.

Hereinafter, a user of the self-terminal device 10-1 may be referred to as a “self-user”, and a user of the counterpart terminal device 10-2 may be referred to as a “counterpart user”. Furthermore, a case where the terminal device 10 is the self-terminal device 10-1 will be described below as an example.

A speech of an utterance of the self-user (which may hereinafter be referred to as a “self-utterance speech”) and a speech other than the self-utterance speech are input to the speech input unit 13. The speech input unit 13 converts the input speech into a speech signal, and outputs the speech signal after conversion (which may hereinafter be referred to as a “self-input speech”) to the communication unit 15, the self-utterance detection unit 31, and the self-utterance buffer 51.

The self-utterance detection unit 31 detects a section of the self-utterance speech in the self-input speech (which may hereinafter be referred to as a “self-utterance section”) by using, for example, voice activity detection (VAD), and outputs a speech signal (that is, the self-utterance speech) of the self-utterance section to the speech recognition unit 32. Furthermore, the self-utterance detection unit 31 outputs flags (which may hereinafter be referred to as “self-utterance section flags”) indicating a start time point and an end time point of the self-utterance section to the speech recognition unit 32 and the self-utterance control unit 33. The self-utterance detection unit 31 outputs the self-utterance section flag set to “ON” at the start time point of the self-utterance section, and outputs the self-utterance section flag set to “OFF” at the end time point of the self-utterance section.

The speech recognition unit 32 converts the self-utterance speech into a text by performing speech recognition for the self-utterance speech by using, for example, automatic speech recognition (ASR), and outputs the text after conversion (which may hereinafter be referred to as “self-utterance text”) to the communication unit 15 and the self-utterance control unit 33 as a speech recognition result. Since it takes a little time for the speech recognition, the speech recognition unit 32 outputs an initial intermediate result of the speech recognition at a time point slightly delayed from the start time point of the self-utterance section (that is, a time point at which the self-utterance section flag set to “ON” is input), continues to output an intermediate result of the speech recognition in the self-utterance section, and outputs a final result of the speech recognition after a predetermined time elapses from the end time point of the self-utterance section (that is, a time point at which the self-utterance section flag set to “OFF” is input).

The communication unit 15 transmits the self-input speech, the intermediate result of the speech recognition (that is, a part of the self-utterance text in the middle of conversion) (which may hereinafter be referred to as a “intermediate self-utterance text result”), and the final result (that is, the entire self-utterance text after the completion of the conversion) of the speech recognition (which may hereinafter be referred to as a “final self-utterance text result”) to the counterpart terminal device 10-2.

Processing similar to that in the self-terminal device 10-1 is also performed in the counterpart terminal device 10-2. Therefore, hereinafter, a speech signal after conversion by the speech input unit 13 of the counterpart terminal device 10-2 may be referred to as a “counterpart input speech”, a speech of an utterance of the counterpart user included in the counterpart input speech may be referred to as a “counterpart utterance speech”, a section of the counterpart utterance speech in the counterpart input speech may be referred to as a “counterpart utterance section”, flags indicating a start time point and an end time point of the counterpart utterance section may be referred to as “counterpart utterance section flags”, and a text after conversion by speech recognition for the counterpart utterance speech may be referred to as a “counterpart utterance text”. That is, in the counterpart terminal device 10-2, the counterpart input speech corresponds to the self-input speech, the counterpart utterance speech corresponds to the self-utterance speech, the counterpart utterance section corresponds to the self-utterance section, the counterpart utterance section flag corresponds to the self-utterance section flag, and the counterpart utterance text corresponds to the self-utterance text, in a correspondence relationship with the self-terminal device 10-1.

The communication unit 15 receives, from the counterpart terminal device 10-2, the counterpart input speech, an intermediate result (that is, a part of the counterpart utterance text in the middle of conversion) of the speech recognition in the counterpart terminal device 10-2 (which may hereinafter be referred to as a “intermediate counterpart utterance text result”), and a final result (that is, the entire counterpart utterance text after the completion of the conversion) of the speech recognition in the counterpart terminal device 10-2 (which may hereinafter be referred to as a “final counterpart utterance text result”), outputs the intermediate counterpart utterance text result and the final counterpart utterance text result to the self-utterance control unit 33, the translation processing unit 34, the natural language processing unit 37, and the counterpart utterance control unit 39, and outputs the counterpart input speech to the delay processing unit 36. Since the intermediate counterpart utterance text result is a result of original speech recognition based on the counterpart input speech, the initial intermediate counterpart utterance text result is received by the communication unit 15 slightly later than the counterpart input speech.

The translation processing unit 34 translates the final counterpart utterance text result into a native language of the self-user, and outputs the translated utterance text (which may hereinafter be referred to as a “translated counterpart utterance text”) to the speech synthesis unit 35.

The speech synthesis unit 35 converts the translated counterpart utterance text into a speech signal by, for example, speech synthesis using text-to-speech (TTS), and outputs the speech signal after conversion to the speech output unit 14.

The speech output unit 14 converts the speech signal after conversion by the speech synthesis unit 35 into a speech, and outputs the speech after conversion (that is, the counterpart utterance speech translated into the native language of the self-user) to the self-user. Hereinafter, the counterpart utterance speech translated into the native language of the self-user may be referred to as a “translated counterpart utterance speech”.

The self-utterance control unit 33 outputs the final self-utterance text result to the translation processing unit 34. The translation processing unit 34 translates the final self-utterance text result into a native language of the counterpart user, translates the translation result into the native language of the self-user again, and outputs an utterance text after the retranslation (which may hereinafter be referred to as a “translated self-utterance text”) to the speech synthesis unit 35. The speech synthesis unit 35 converts the translated self-utterance text into a speech signal by, for example, speech synthesis using TTS, and outputs the speech signal after conversion to the speech output unit 14. The speech output unit 14 converts the speech signal after conversion by the speech synthesis unit 35 into a speech, and outputs the speech after conversion (that is, the self-utterance speech retranslated into the native language of the self-user) to the self-user.

Furthermore, the self-utterance control unit 33 causes the self-utterance buffer 51 to start recording of the self-input speech at a time point when the self-utterance section flag set to “ON” is input, and causes the self-utterance buffer 51 to stop recording of the self-input speech at a time point when the self-utterance section flag set to “OFF” is input or at a time point when the initial intermediate self-utterance text result is received. As a result, the self-utterance speech is recorded in the self-utterance buffer 51. Furthermore, when the self-utterance control unit 33 has detected a predetermined verbalization request phrase in the intermediate counterpart utterance text result input within a predetermined time from the time point at which the recording of the self-input speech is stopped in the self-utterance buffer 51, the self-utterance control unit 33 outputs the self-input speech recorded in the self-utterance buffer 51 from the self-utterance buffer 51 to the speech output unit 14, then extracts the verbalization request phrase from the intermediate counterpart utterance text result, and outputs a native language phrase corresponding to the extracted verbalization request phrase (which may hereinafter be referred to as “native language verbalization request phrase”) to the speech synthesis unit 35. The speech synthesis unit 35 converts the native language verbalization request phrase into a speech signal by, for example, speech synthesis using TTS, and outputs the speech signal after conversion to the speech output unit 14. The speech output unit 14 outputs the self-input speech input from the self-utterance buffer 51 to the self-user, and then outputs the speech signal after conversion (that is, a speech of the native language verbalization request phrase) to the self-user.

Furthermore, when the self-utterance control unit 33 has detected a predetermined utterance cancellation phrase in the intermediate self-utterance text result, the self-utterance control unit 33 discards the intermediate self-utterance text result up to a detection time point.

On the other hand, as described above, since the initial intermediate counterpart utterance text result is received by the communication unit 15 slightly later than the counterpart input speech, the delay processing unit 36 delays the counterpart input speech input from the communication unit 15 by a predetermined time in order to match a timing of the counterpart input speech with a timing of the intermediate counterpart utterance text result, and outputs the delayed counterpart input speech to the counterpart utterance detection unit 38, the muting/ducking unit 42, and the counterpart utterance buffer 52. For example, the delay processing unit 36 delays the counterpart input speech by 0.5 seconds.

The natural language processing unit 37 analyzes modification structures of words in the intermediate counterpart utterance text result and the final counterpart utterance text result by using, for example, natural language processing (NLP), and outputs the analysis result to the counterpart utterance control unit 39.

At a time point when the initial intermediate counterpart utterance text result is input, the counterpart utterance control unit 39 outputs a muting or ducking processing start instruction for the counterpart input speech to the muting/ducking unit 42, and outputs an output start instruction for a sound effect indicating that the current turn in the conversation is a counterpart user's turn (which may hereinafter be referred to as a “counterpart turn sound effect”) to the sound effect generation unit 41. The muting/ducking unit 42 starts muting or ducking for the counterpart input speech in accordance with the processing start instruction from the counterpart utterance control unit 39.

Here, “muting” is processing for silencing the counterpart input speech, and “ducking” is processing for reducing the volume of the counterpart input speech. Whether the muting/ducking unit 42 performs mute or ducking on the counterpart input speech is set in the muting/ducking unit 42 in advance. The muting/ducking unit 42 outputs a speech after muting or ducking (which may hereinafter be referred to as an “MD speech”) to the counterpart utterance synthesis unit 43. Furthermore, the sound effect generation unit 41 starts generation of the counterpart turn sound effect in accordance with the output start instruction from the counterpart utterance control unit 39, and outputs the generated counterpart turn sound effect to the speech output unit 14. The speech output unit 14 outputs the counterpart turn sound effect to the self-user.

The counterpart utterance synthesis unit 43 synthesizes the counterpart input speech output from the counterpart utterance buffer 52 with the MD voice and outputs a speech after synthesis to the speech output unit 14. The speech output unit 14 outputs the counterpart input speech synthesized with the MD voice to the self-user.

Furthermore, the translation processing unit 34 outputs a translation completion notification to the counterpart utterance control unit 39 at a time point when translation of the final counterpart utterance text result is completed. The counterpart utterance control unit 39 outputs a muting or ducking processing stop instruction for the counterpart input speech to the muting/ducking unit 42 and outputs an output stop instruction for the counterpart turn sound effect to the sound effect generation unit 41 at a time point when both the input of the final counterpart utterance text result and the input of the translation completion notification are confirmed. The muting/ducking unit 42 stops muting or ducking of the counterpart input speech in accordance with the processing stop instruction from the counterpart utterance control unit 39. Furthermore, the sound effect generation unit 41 stops generation and output of the counterpart turn sound effect in accordance with the output stop instruction from the counterpart utterance control unit 39.

The counterpart utterance detection unit 38 detects the counterpart utterance section in the counterpart input speech by using, for example, the voice activity detection (VAD), and outputs the counterpart utterance section flag to the counterpart utterance control unit 39. The counterpart utterance detection unit 38 outputs the counterpart utterance section flag set to “ON” at the start time point of the counterpart utterance section, and outputs the counterpart utterance section flag set to “OFF” at the end time point of the counterpart utterance section.

Here, in the self-utterance section, there are a section in which the self-user utters a language (which may hereinafter be referred to as a “self-language section”) and a section in which the self-user makes a sound other than the language (which may hereinafter be referred to as a “self-non-language section”). Similarly, in the counterpart utterance section, there are a section in which the counterpart user utters a language (which may hereinafter be referred to as a “counterpart language section”) and a section in which the counterpart user makes a sound other than the language (which may hereinafter be referred to as a “counterpart non-language section”).

Furthermore, in the self-utterance section, the self-language section corresponds to a section in which the self-utterance text exists, and the self-non-language section corresponds to a section in which the self-utterance text does not exist. Similarly, in the counterpart utterance section, the counterpart language section corresponds to a section in which the counterpart utterance text exists, and the counterpart non-language section corresponds to a section in which the counterpart utterance text does not exist.

Therefore, the counterpart utterance control unit 39 detects the counterpart non-language section in the counterpart input speech during a period from a time point when the initial intermediate counterpart utterance text result is input to a time point when the final counterpart utterance text result is input. For example, in a case where there is no input of the intermediate counterpart utterance text result for a predetermined time or more after the time point when the counterpart utterance section flag set to “ON” is input, the counterpart utterance control unit 39 detects a section in which there is no input of the intermediate counterpart utterance text result as the counterpart non-language section. Furthermore, the counterpart utterance control unit 39 causes the counterpart utterance buffer 52 to start recording of the counterpart input speech at a start time point of the counterpart non-language section, and causes the counterpart utterance buffer 52 to stop recording of the counterpart input speech at an end time point of the counterpart non-language section. At this time, the counterpart utterance control unit 39 gives a time stamp to the recorded counterpart input speech. As a result, the counterpart input speech in the counterpart non-language section is recorded in the counterpart utterance buffer 52 with the time stamp.

Furthermore, when the final counterpart utterance text result is input, the counterpart utterance control unit 39 compares a time stamp of each word in the final counterpart utterance text result with the time stamp of the counterpart input speech recorded in the counterpart utterance buffer 52, thereby specifying at which position in the counterpart utterance text the counterpart input speech in the counterpart non-language section has been uttered. That is, the counterpart utterance control unit 39 specifies an utterance position of the counterpart input speech in the counterpart non-language section. For example, the counterpart utterance control unit 39 specifies, as the counterpart non-language section in the counterpart utterance text, a position of a word having a time stamp of the same value as the time stamp of the counterpart input speech in the counterpart non-language section among a plurality of words in the final counterpart utterance text result.

Furthermore, the counterpart utterance control unit 39 determines whether or not the position of the counterpart non-language section in the counterpart utterance text is at a word boundary with modification based on the analysis result of the natural language processing unit 37.

When the position of the counterpart non-language section is not at a word boundary with modification, that is, when the position of the counterpart non-language section is at a word boundary without modification, the counterpart utterance control unit 39 determines that there is a non-language utterance of the counterpart user at a break of a sentence. Therefore, when the position of the counterpart non-language section is at a word boundary without modification, the counterpart utterance control unit 39 controls the translation processing unit 34 and the counterpart utterance buffer 52 to output the translated counterpart utterance text before the non-language utterance from the translation processing unit 34, then output the counterpart input speech in the counterpart non-language section from the counterpart utterance buffer 52, and then output the translated counterpart utterance text after the non-language utterance from the translation processing unit 34. As a result, the speeches are output from the speech output unit 14 to the self-user in the order of the translated counterpart utterance speech before the non-language utterance, the counterpart input speech in the counterpart non-language section, and the translated counterpart utterance speech after the non-language utterance.

On the other hand, when the position of the counterpart non-language section is at a word boundary with modification, the counterpart utterance control unit 39 determines that there is a non-language utterance of the counterpart user in the middle of a sentence. Therefore, when the position of the counterpart non-language section is at a word boundary with modification, the counterpart utterance control unit 39 controls the translation processing unit 34 and the counterpart utterance buffer 52 to output the translated counterpart utterance text from the translation processing unit 34 and simultaneously output the counterpart input speech in the counterpart non-language section from the counterpart utterance buffer 52. As a result, the counterpart input speech in the counterpart non-language section and the translated counterpart utterance speech are output in an overlapping manner from the speech output unit 14 to the self-user.

Furthermore, when the counterpart utterance control unit 39 has detected a predetermined utterance cancellation phrase in the intermediate counterpart utterance text result, the counterpart utterance control unit 39 outputs an output instruction for a sound effect indicating that the utterance of the counterpart user has been canceled (which may hereinafter be referred to as a “cancellation sound effect”) to the sound effect generation unit 41. The sound effect generation unit 41 generates the cancellation sound effect in accordance with the output instruction from the counterpart utterance control unit 39, and outputs the generated cancellation sound effect to the speech output unit 14. The speech output unit 14 outputs the cancellation sound effect to the self-user.

Furthermore, in a case where the sound effect generation unit 41 is outputting the counterpart turn sound effect at a time point when the predetermined utterance cancellation phrase has been detected in the intermediate counterpart utterance text result, the counterpart utterance control unit 39 causes the sound effect generation unit 41 to stop generating and outputting the counterpart turn sound effect, and outputs a muting or ducking processing stop instruction for the counterpart input speech to the muting/ducking unit 42.

In a case where the translated counterpart utterance speech is being output at a time point when the predetermined utterance cancellation phrase has been detected in the intermediate counterpart utterance text result, the counterpart utterance control unit 39 immediately stops the output of the translated counterpart utterance speech.

<Processing Procedure in Terminal Device>

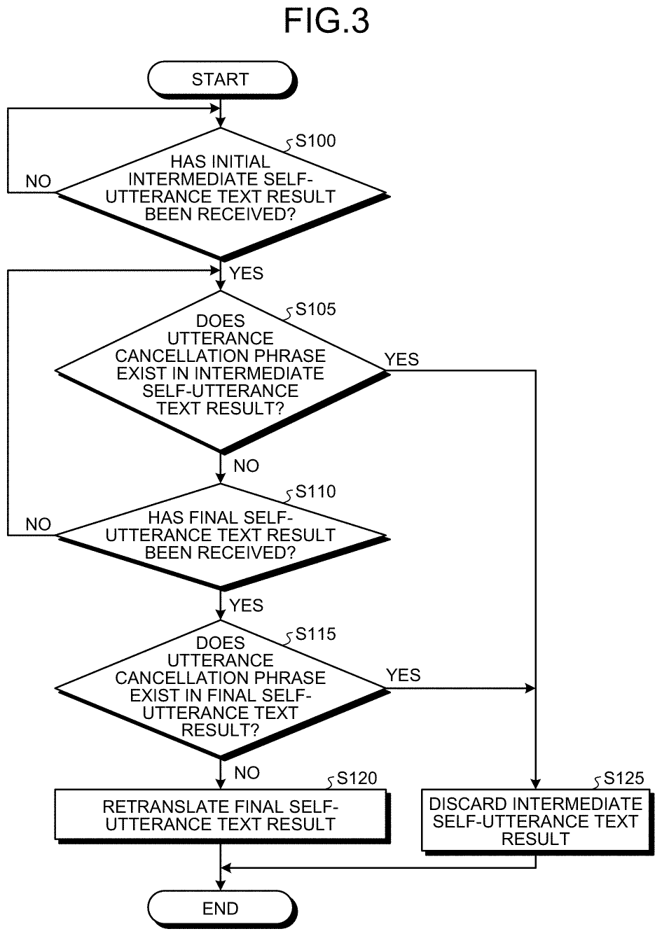

FIGS. 3 to 7 are flowcharts illustrating an example of a processing procedure in the terminal device according to the first embodiment of the present disclosure.

In FIG. 3, in Step S100, the self-utterance control unit 33 determines whether or not the initial intermediate self-utterance text result has been received. The self-utterance control unit 33 continues the processing of Step S100 until the initial intermediate self-utterance text result is received (Step S100: No), and once the self-utterance control unit 33 receives the initial intermediate self-utterance text result (Step S100: Yes), the processing proceeds to Step S105.

In Step S105, the self-utterance control unit 33 determines whether or not a predetermined utterance cancellation phrase exists in the intermediate self-utterance text result. In a case where the predetermined utterance cancellation phrase exists in the intermediate self-utterance text result (Step S105: Yes), the processing proceeds to Step S125, and in a case where the predetermined utterance cancellation phrase does not exist in the intermediate self-utterance text result (Step S105: No), the processing proceeds to Step S110.

In Step S110, the self-utterance control unit 33 determines whether or not the final self-utterance text result has been received. Once the self-utterance control unit 33 receives the final self-utterance text result (Step S110: Yes), the processing proceeds to Step S115. When the self-utterance control unit 33 has not received the final self-utterance text result (Step S110: No), the processing returns to Step S105, and the processing of Step S105 is performed on the intermediate self-utterance text result received as needed by the self-utterance control unit 33.

In Step S115, the self-utterance control unit 33 determines whether or not a predetermined utterance cancellation phrase exists in the final self-utterance text result. In a case where the predetermined utterance cancellation phrase exists in the final self-utterance text result (Step S115: Yes), the processing proceeds to Step S125, and in a case where the predetermined utterance cancellation phrase does not exist in the final self-utterance text result (Step S115: No), the processing proceeds to Step S120.

In Step S120, the self-utterance control unit 33 outputs the final self-utterance text result to the translation processing unit 34, and the translation processing unit 34 outputs the translated self-utterance text obtained by retranslation of the final self-utterance text result to the speech synthesis unit 35. Furthermore, the speech synthesis unit 35 converts the translated self-utterance text into a speech signal, and the speech output unit 14 converts the speech signal into a speech and outputs the speech after conversion (that is, the self-utterance speech retranslated into the native language of the self-user) to the self-user.

On the other hand, in Step S125, the intermediate self-utterance text result up to a time point when the predetermined cancellation phrase is detected is discarded.

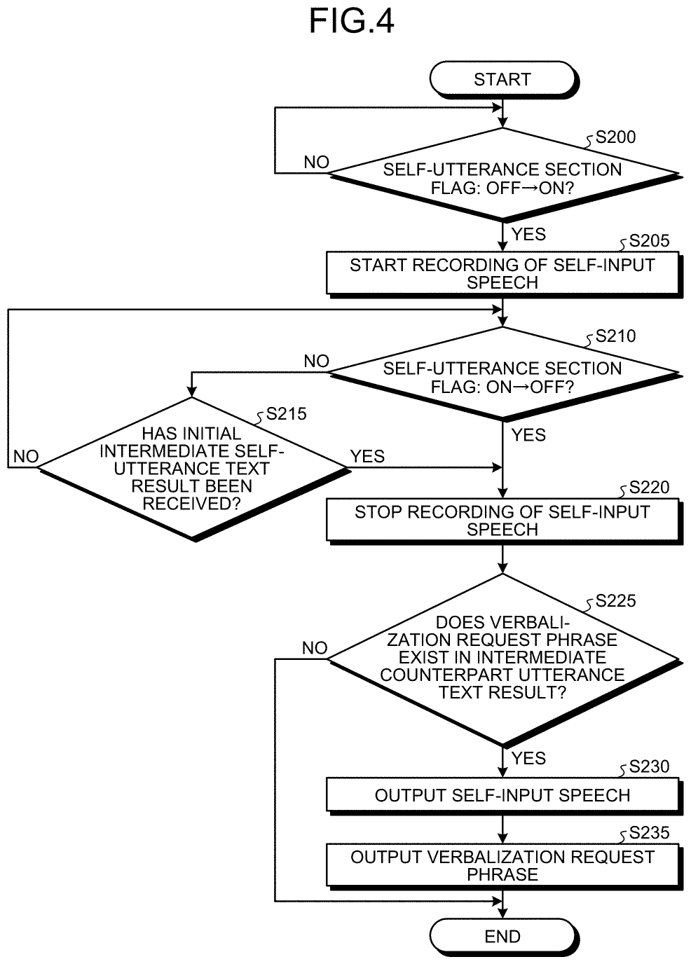

In addition, the processing procedure illustrated in FIG. 4 is performed in parallel with the processing procedure illustrated in FIG. 3.

In FIG. 4, in Step S200, the self-utterance control unit 33 determines whether or not the self-utterance section flag has changed from OFF to ON. In a case where the self-utterance section flag remains OFF (Step S200: No), the self-utterance control unit 33 continues the processing of Step S200, and once the self-utterance section flag changes from OFF to ON (Step S200: Yes), the processing proceeds to Step S205.

In Step S205, the self-utterance control unit 33 causes the self-utterance buffer 51 to start recording of the self-input speech.

In Step S210, the self-utterance control unit 33 determines whether or not the self-utterance section flag has changed from ON to OFF. In a case where the self-utterance section flag remains ON (Step S210: No), the processing proceeds to Step S215, and once the self-utterance section flag changes from ON to OFF (Step S210: Yes), the processing proceeds to Step S220.

In Step S215, the self-utterance control unit 33 determines whether or not the initial intermediate self-utterance text result has been received. When the initial intermediate self-utterance text result has not been received (Step S215: No), the processing returns to Step S210, and once the initial intermediate self-utterance text result is received (Step S215: Yes), the processing proceeds to Step S220.

In Step S220, the self-utterance control unit 33 causes the self-utterance buffer 51 to stop recording of the self-input speech.

In Step S225, the self-utterance control unit 33 determines whether or not a predetermined verbalization request phrase exists in the intermediate counterpart utterance text result received within a predetermined time from a time point when the recording of the self-input speech is stopped. In a case where the predetermined verbalization request phrase exists in the intermediate counterpart utterance text result (Step S225: Yes), the processing proceeds to Step S230, and in a case where the predetermined verbalization request phrase does not exist in the intermediate counterpart utterance text result (Step S125: No), the flowchart ends without performing the processing of Steps S230 and S235.

In Step S230, the self-utterance control unit 33 causes the self-utterance buffer 51 to output the self-input speech recorded in the self-utterance buffer 51 to the speech output unit 14. Furthermore, in Step S235, the self-utterance control unit 33 extracts the verbalization request phrase from the intermediate counterpart utterance text result, and outputs the native language verbalization request phrase corresponding to the extracted verbalization request phrase to the speech synthesis unit 35. As a result, the speech output unit 14 outputs the self-input speech input from the self-utterance buffer 51 to the self-user (Step S230), and then outputs a speech of the native language verbalization request phrase to the self-user (Step S235).

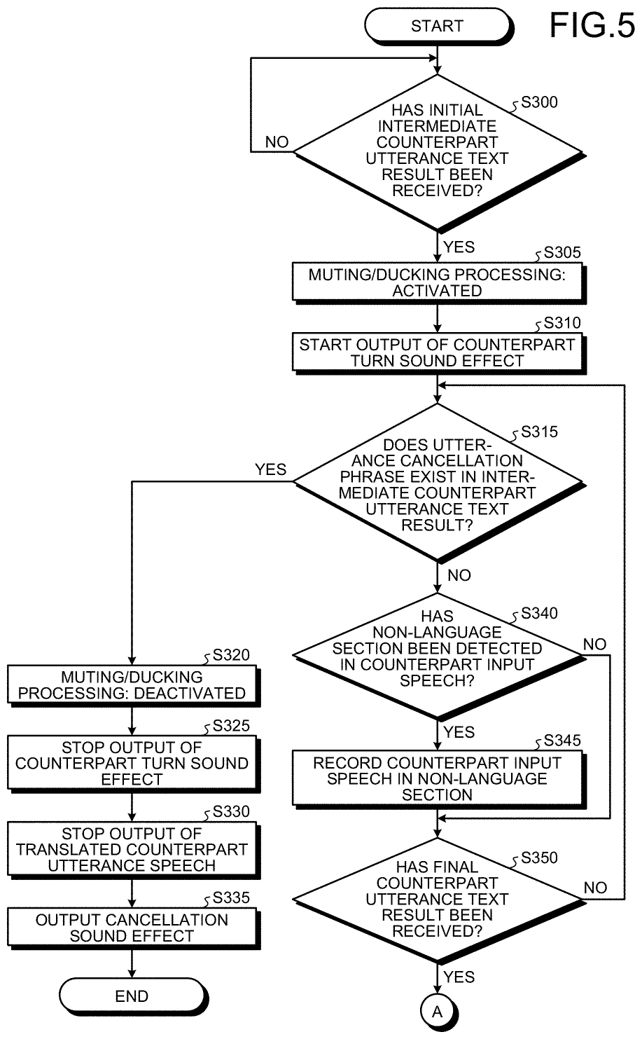

In addition, processing procedures illustrated in FIGS. 5, 6, and 7 are performed in parallel with the processing procedures illustrated in FIGS. 3 and 4.

In FIG. 5, in Step S300, the counterpart utterance control unit 39 determines whether or not the initial intermediate counterpart utterance text result has been received. The counterpart utterance control unit 39 continues the processing of Step S300 until the initial intermediate counterpart utterance text result is received (Step S300: No), and once the counterpart utterance control unit 39 receives the initial intermediate counterpart utterance text result (Step S300: Yes), the processing proceeds to Step S305.

In Step S305, the counterpart utterance control unit 39 activates muting/ducking processing performed by the muting/ducking unit 42.

In Step S310, the counterpart utterance control unit 39 starts output of the counterpart turn sound effect.

In Step S315, the counterpart utterance control unit 39 determines whether or not a predetermined utterance cancellation phrase exists in the intermediate counterpart utterance text result. In a case where the predetermined utterance cancellation phrase exists in the intermediate counterpart utterance text result (Step S315: Yes), the processing proceeds to Step S320, and in a case where the predetermined utterance cancellation phrase does not exist in the intermediate counterpart utterance text result (Step S315: No), the processing proceeds to Step S340.

In Step S320, the counterpart utterance control unit 39 deactivates the muting/ducking processing performed by the muting/ducking unit 42.

In Step S325, the counterpart utterance control unit 39 stops output of the counterpart turn sound effect.

In Step S330, the counterpart utterance control unit 39 stops output of the translated counterpart utterance speech.

In Step S335, the counterpart utterance control unit 39 outputs the cancellation sound effect.

On the other hand, in Step S340, the counterpart utterance control unit 39 determines whether or not the counterpart non-language section has been detected in the counterpart input speech. In a case where the counterpart non-language section has been detected in the counterpart input speech (Step S340: Yes), the processing proceeds to Step S345, and in a case where the counterpart non-language section has not been detected in the counterpart input speech (Step S340: No), the processing proceeds to Step S350 without performing the processing of Step S345.

In Step S345, the counterpart utterance control unit 39 records the counterpart input speech in the counterpart non-language section in the counterpart utterance buffer 52 with the time stamp.

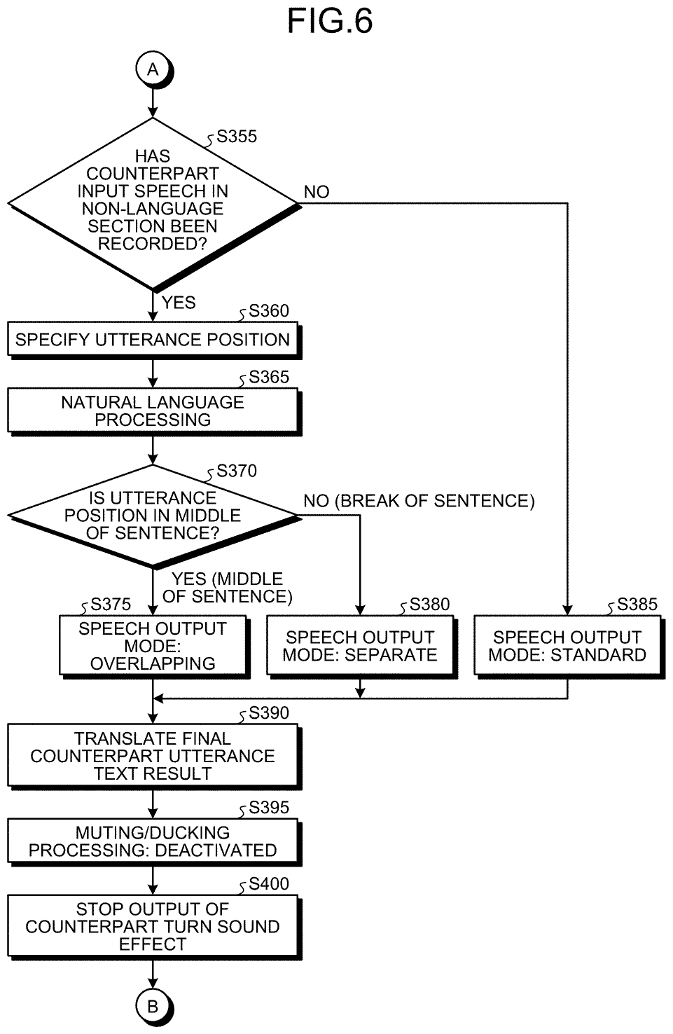

In Step S350, the counterpart utterance control unit 39 determines whether or not the final counterpart utterance text result has been received. Once the counterpart utterance control unit 39 receives the final counterpart utterance text result (Step S350: Yes), the processing proceeds to Step S355 (FIG. 6), and when the counterpart utterance control unit 39 has not received the final counterpart utterance text result (Step S350: No), the processing returns to Step S315, and the processing of Step S315 is performed on the intermediate counterpart utterance text result received as needed by the counterpart utterance control unit 39.

In Step S355 (FIG. 6), the counterpart utterance control unit 39 determines whether or not the counterpart input speech in the counterpart non-language section has been recorded in the counterpart utterance buffer 52. In a case where the counterpart input speech in the counterpart non-language section has been recorded in the counterpart utterance buffer 52 (Step S355: Yes), the processing proceeds to Step S360, and in a case where the counterpart input speech in the counterpart non-language section has not been recorded in the counterpart utterance buffer 52 (Step S355: No), the processing proceeds to Step S385.

In Step S360, the counterpart utterance control unit 39 specifies the utterance position of the counterpart input speech in the counterpart non-language section.

In Step S365, the natural language processing unit 37 analyzes the modification structures of the words in the intermediate counterpart utterance text result and the final counterpart utterance text result, and outputs the analysis result to the counterpart utterance control unit 39.

In Step S370, the counterpart utterance control unit 39 determines whether or not the position of the counterpart non-language section in the counterpart utterance text is at a word boundary with modification based on the analysis result of the natural language processing unit 37. When the position of the counterpart non-language section is at a word boundary with modification, the counterpart utterance control unit 39 determines that there is a non-language utterance of the counterpart user in the middle of the sentence, that is, the utterance position of the counterpart input speech in the counterpart non-language section is in the middle of the sentence (Step S370: Yes), and the processing proceeds to Step S375. On the other hand, when the position of the counterpart non-language section is at a word boundary without modification, the counterpart utterance control unit 39 determines that there is a non-language utterance of the counterpart user at a break of the sentence, that is, the utterance position of the counterpart input speech in the counterpart non-language section is at the break of the sentence (Step S370: No), and the processing proceeds to Step S380.

In Step S375, the counterpart utterance control unit 39 sets a speech output mode to “overlapping”. In Step S380, the counterpart utterance control unit 39 sets the speech output mode to “separate”. In Step S385, the counterpart utterance control unit 39 sets the speech output mode to “standard”.

In Step S390, the translation processing unit 34 translates the final counterpart utterance text result into the native language of the self-user.

In Step S395, the counterpart utterance control unit 39 deactivates the muting/ducking processing performed by the muting/ducking unit 42.

In Step S400, the counterpart utterance control unit 39 stops output of the counterpart turn sound effect.

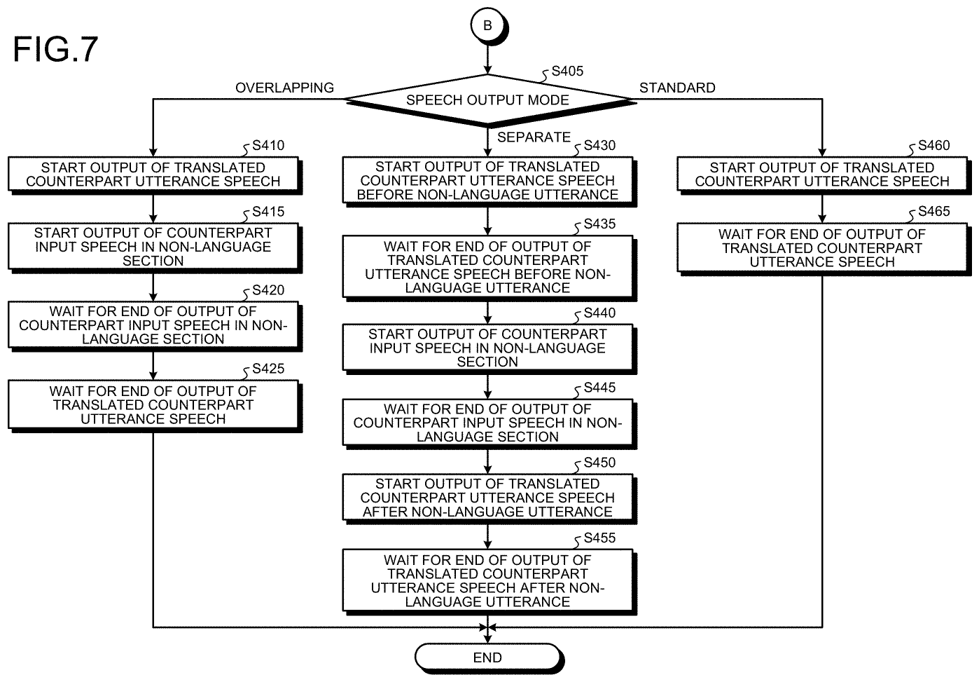

In Step S405 (FIG. 7), the counterpart utterance control unit 39 determines the speech output mode. In a case where the speech output mode is “overlapping”, the processing proceeds to Step S410. In a case where the speech output mode is “separate”, the processing proceeds to Step S430. In a case where the speech output mode is “standard”, the processing proceeds to Step S460.

In Step S410, the counterpart utterance control unit 39 starts output of the translated counterpart utterance speech.

In Step S415, the counterpart utterance control unit 39 starts output of the counterpart input speech in the counterpart non-language section.

In Step S420, the counterpart utterance control unit 39 waits for the end of the output of the counterpart input speech in the counterpart non-language section. Once the output of the counterpart input speech in the counterpart non-language section ends, the processing proceeds to Step S425.

In Step S425, the counterpart utterance control unit 39 waits for the end of the output of the translated counterpart utterance speech. Once the output of the translated counterpart utterance speech ends, the flowchart ends.

Furthermore, in Step S430, the counterpart utterance control unit 39 starts output of the translated counterpart utterance speech before the non-language utterance.

In Step S435, the counterpart utterance control unit 39 waits for the end of the output of the translated counterpart utterance speech before the non-language utterance. Once the output of the translated counterpart utterance speech before the non-language utterance ends, the processing proceeds to Step S440.

In Step S440, the counterpart utterance control unit 39 starts output of the counterpart input speech in the counterpart non-language section.

In Step S445, the counterpart utterance control unit 39 waits for the end of the output of the counterpart input speech in the counterpart non-language section. Once the output of the counterpart input speech in the counterpart non-language section ends, the processing proceeds to Step S450.

In Step S450, the counterpart utterance control unit 39 starts output of the translated counterpart utterance speech after the non-language utterance.

In Step S455, the counterpart utterance control unit 39 waits for the end of the output of the translated counterpart utterance speech after the non-language utterance. Once the output of the translated counterpart utterance speech after the non-language utterance ends, the flowchart ends.

Furthermore, in Step S460, the counterpart utterance control unit 39 starts output of the translated counterpart utterance speech.

In Step S465, the counterpart utterance control unit 39 waits for the end of the output of the translated counterpart utterance speech. Once the output of the translated counterpart utterance speech ends, the flowchart ends.

<Operation of Remote Communication System>

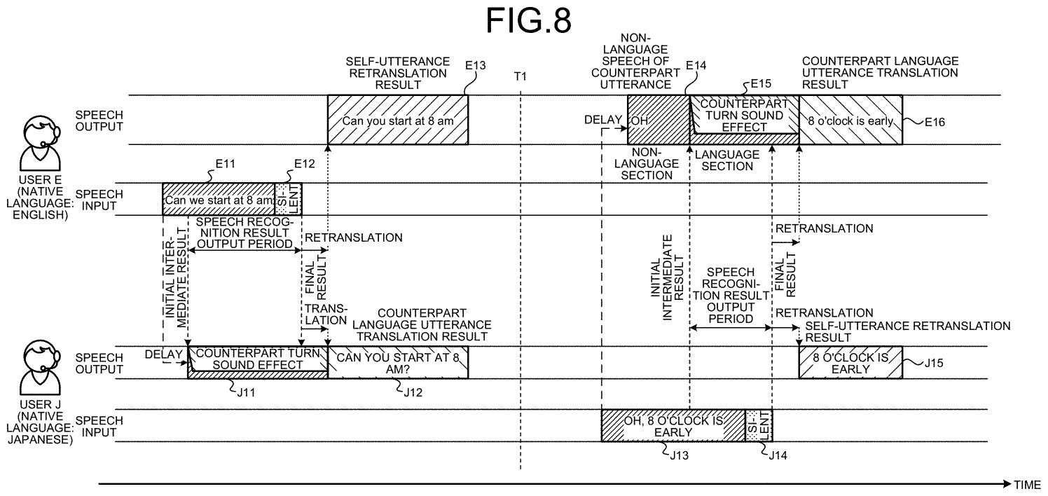

FIGS. 8 to 15 are diagrams for explaining an operation example of the remote communication system according to the first embodiment of the present disclosure. Hereinafter, each of Operation Examples 1 to 8 will be described. In Operation Examples 1 to 8, a user E is the self-user who uses the self-terminal device 10-1, and a user J is the counterpart user who uses the counterpart terminal device 10-2. In addition, the native language of the user E is English, and the native language of the user J is Japanese.

### Operation Example 1 (FIG. 8)

In FIG. 8, an utterance “Can we start at 8 am?” made by the user E in a section E11 is translated from English into Japanese by the self-terminal device 10-1 after a silent section E12, and then further retranslated into English, and a speech “Can you start at 8 am?” is output to the user E in a section E13.

The user E can check whether there is no mistake in speech recognition or translation by hearing the retranslation result for his/her utterance, and can check how the translation result is conveyed to the user J.

Furthermore, while the user E makes the utterance in the section E11, the counterpart terminal device 10-2 outputs the counterpart turn sound effect to the user J in a section J11. Furthermore, the utterance “Can we start at 8 am?” made by the user E in the section E11 is translated by the counterpart terminal device 10-2, and a Japanese speech “Can you start at 8 am?” is output to the user J in a section J12 at the same timing as the section E13.

Furthermore, an utterance “Oh, 8 o'clock is early” made by the user J in a section J13 is translated from Japanese into English by the counterpart terminal device 10-2 after a silent section J14, and then further retranslated into Japanese, and a Japanese speech “8 o'clock is early” is output to the user J in a section J15.

The user J can check whether there is no mistake in speech recognition or translation by hearing the retranslation result for his/her utterance, and can check how the translation result is conveyed to the user E.

Furthermore, the self-terminal device 10-1 that has received the utterance of the user J, “Oh, 8 o'clock is early” outputs the speech “Oh” in the non-language section in the utterance “Oh, 8 o'clock is early” as it is in a section E14 without translating the speech “Oh”. Furthermore, the self-terminal device 10-1 outputs the counterpart turn sound effect to the user E in a section E15 after the section E14 while the user J makes the utterance in the section J13. Furthermore, the self-terminal device 10-1 translates the speech “8 o'clock is early” in the language section in the utterance “Oh, 8 o'clock is early” and outputs a speech “8 o'clock is early” to the user E in a section E16 at the same timing as the section J15.

In this manner, the user E and the user J can hear the retranslation results for their utterances (the section E13 and the section J15) while the counterparts are hearing the translation results (the section J12 and the section E16). Therefore, an additional time for checking is not taken during the conversation, and there is no silent time during the conversation. Therefore, natural turn-taking can be made.

Furthermore, since the user E can hear “Oh”, which is the non-language utterance of the user J, with a raw voice, it is possible to know that the user J takes an attitude that expresses rejection from the nuances such as intonation of the non-language utterance “Oh”. Therefore, the user E can grasp the degree of rejection of the user J in the language utterance “8 o'clock is early” following the non-language utterance “Oh”.

Furthermore, since the user E can hear the speech “Oh”, which is a non-language utterance of the user J, in real time immediately after hearing the speech “Can you start at 8 am?”, which is the retranslation result for the utterance “Can we start at 8 am?”, the user E can quickly and naturally receive a response and a reaction to a content delivered to the user J. A similar effect can be obtained even in a case where the non-language utterance of the user J is an affirmative quick response such as “Yeah”.

In FIG. 8, the order of the speech output to the user E is “Oh” (section E14)→the counterpart turn sound effect (section E15)→“8 o'clock is early” (section E16). Alternatively, the order of the speech output to the user E may be the counterpart turn sound effect→“Oh”→“8 o'clock is early”. As a result, the non-language utterance “Oh” and the translation result “8 o'clock is early” are consecutively output, so that the degree of understanding of the user E with respect to the conversation can be enhanced.

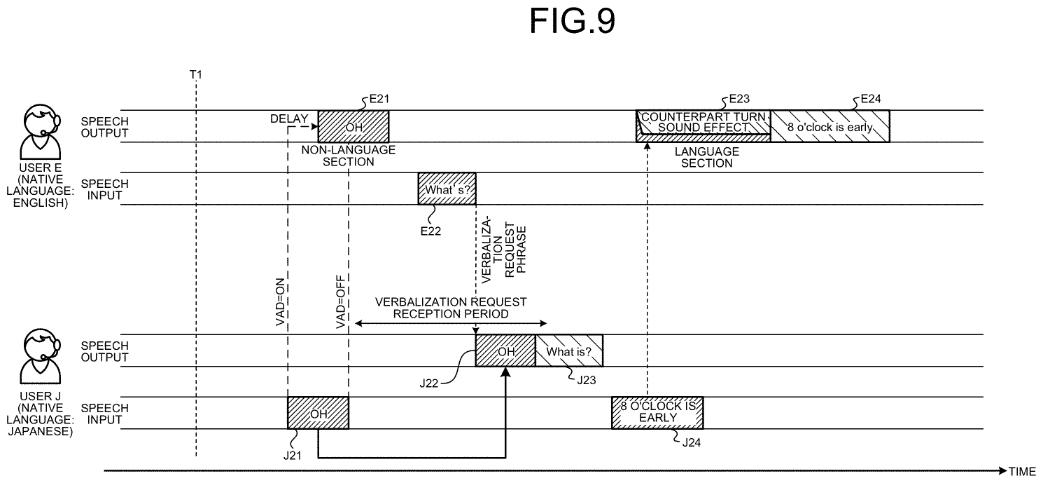

### Operation Example 2 (FIG. 9)

In FIG. 9, since an operation up to a time T1 is the same as Operation Example 1 (FIG. 8), a description thereof will be omitted.

In FIG. 9, the self-terminal device 10-1 that has received an utterance “Oh” of the user J in a section J21 outputs the speech “Oh” in the non-language section as it is in a section E21 without translating the speech “Oh”.

The user E who has not been able to understand the intention of the non-language utterance “Oh” output in the section E21 utters “What?” which is a predetermined verbalization request phrase in a section E22.

Since the verbalization request phrase “What?” has been detected in the intermediate counterpart utterance text result within a predetermined time (that is, within a verbalization request reception period) after the self-utterance section flag is set to “OFF”, the counterpart terminal device 10-2 outputs a Japanese speech “What is?”, which is the native language verbalization request phrase corresponding to the verbalization request phrase “What?” in a section J23 immediately after the speech of the non-language utterance “Oh” is output in a section J22. The user J can know that the user E could not understand the intention of the non-language utterance “Oh” by hearing “What is Oh?” which is a series of speech outputs in the sections J22 and J23. Therefore, the user J makes, in a section J24, an utterance “8 o'clock is early” which is a language for explaining the intention of the non-language utterance “Oh”.

The self-terminal device 10-1 outputs the counterpart turn sound effect to the user E in a section E23 while the user J makes the utterance in the section J24. Furthermore, the self-terminal device 10-1 translates the speech “8 o'clock is early” in the language section, and outputs a speech “8 o'clock is early” to the user E in a section E24.

In this way, the user E can understand the intention of the non-language utterance “Oh” in a short turn time. Furthermore, in a case where the user cannot understand the non-language utterance of the counterpart, the user can quickly understand the intention of the counterpart because the turn-taking is made with a low latency without waiting for the end of the utterance and the completion of the translation. Furthermore, by limiting the reception of the verbalization request after the non-language utterance to being made within a predetermined time, it is possible to prevent erroneous output of the native language verbalization request phrase caused by detection of an unnecessary verbalization request phrase.

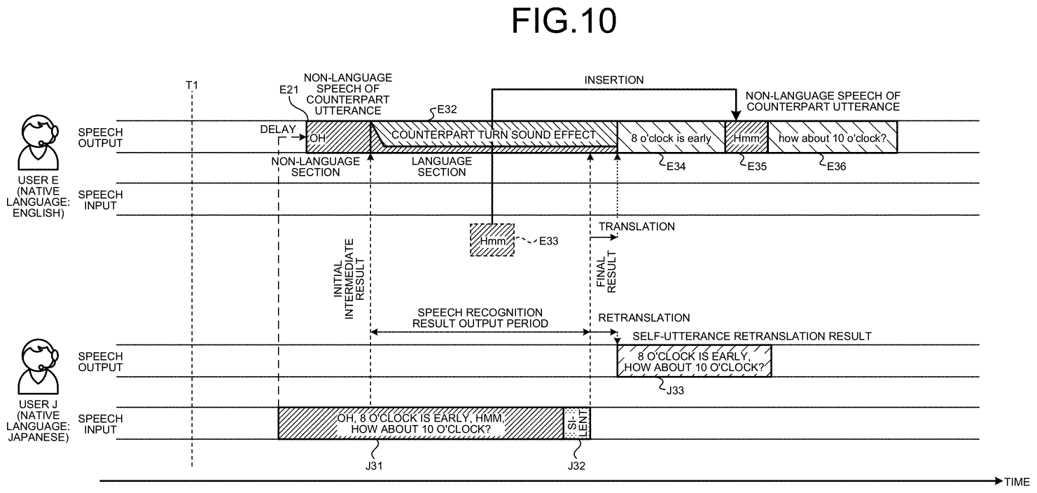

### Operation Example 3 (FIG. 10)

In FIG. 10, since an operation up to the time T1 is the same as Operation Example 1 (FIG. 8), a description thereof will be omitted.

In FIG. 10, an utterance “Oh, 8 o'clock is early, hmm, how about 10 o'clock?” made by the user J in a section J31 is translated from Japanese into English by the counterpart terminal device 10-2 after a silent section J32, and then further retranslated into Japanese, and a Japanese speech “8 o'clock is early, how about 10 o'clock?” is output to the user J in a section J33.

Furthermore, the self-terminal device 10-1 that has received the utterance of the user J, “Oh, 8 o'clock is early, hmm, how about 10 o'clock?” outputs the speech “Oh” in the non-language section in the utterance “Oh, 8 o'clock is early, hmm, how about 10 o'clock?” as it is in a section E31 without translating the speech “Oh”. Furthermore, the self-terminal device 10-1 outputs the counterpart turn sound effect to the user E in a section E32 after the section E31 while the user J makes the utterance in the section J31. Furthermore, in the self-terminal device 10-1, the non-language utterance “hmm” in the utterance “8 o'clock is early, hmm, how about 10 o'clock?” is detected and recorded. Since the position of the non-language utterance “hmm” in the counterpart utterance text is between “8 o'clock is early” and “how about 10 o'clock” having no modification relationship, the position of “hmm” is at a word boundary without modification. Therefore, in the self-terminal device 10-1, “hmm”, which is a speech of the non-language utterance, is directly inserted without being translated between “8 o'clock is early” (section E34), which is a translation result for the Japanese language utterance “8 o'clock is early”, and “how about 10 o'clock?” (section E36), which is a translation result for the Japanese language utterance “how about 10 o'clock” (section E35).

The user E can know that the user J hesitates about his/her proposal by directly hearing “hmm” which is the non-language utterance of the user J. On the other hand, if the utterance content of the user J in the section J31 is “8 o'clock is early, yeah! how about 10 o'clock?”, the user E can know that the user J is confident in his/her proposal by directly hearing “yeah!” which is the non-language utterance of the user J. Furthermore, it is possible to convey to the listener the attitude of the speaker, for example, whether or not the speaker is hesitating, by inserting a non-language utterance speech in the language section into an appropriate position in the translated counterpart utterance speech.

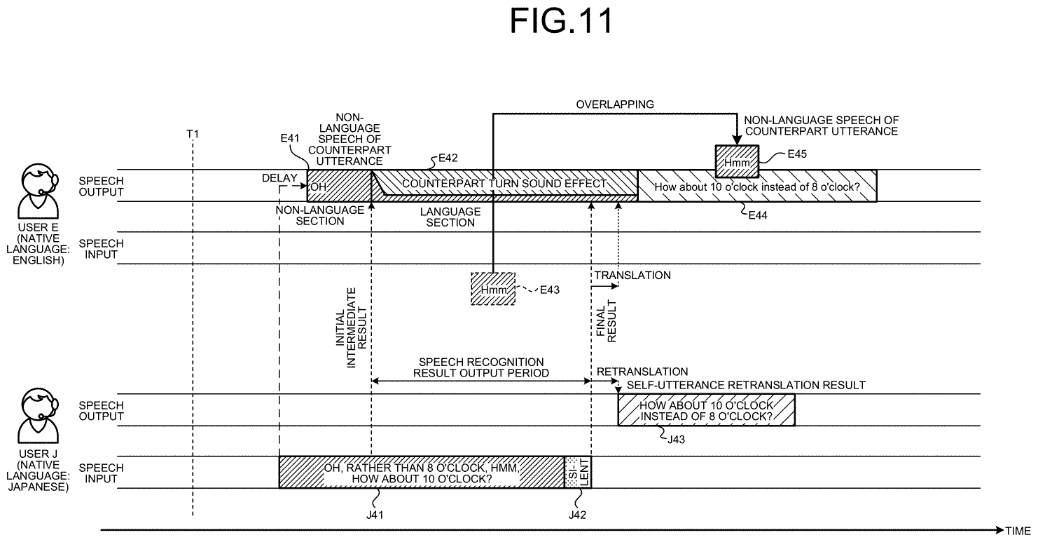

### Operation Example 4 (FIG. 11)

In FIG. 11, since an operation up to the time T1 is the same as Operation Example 1 (FIG. 8), a description thereof will be omitted.

In FIG. 11, an utterance “Oh, rather than 8 o'clock, hmm, how about 10 o'clock?” made by the user J in a section J41 is translated from Japanese into English by the counterpart terminal device 10-2 after a silent section J42, and then further retranslated into Japanese, and a Japanese speech “How about 10 o'clock instead of 8 o'clock?” is output to the user J in a section J43.

Furthermore, the self-terminal device 10-1 that has received the utterance of the user J, “Oh, rather than 8 o'clock, hmm, how about 10 o'clock?” outputs the speech “Oh” in the non-language section in the utterance “Oh, rather than 8 o'clock, hmm, how about 10 o'clock?” as it is in a section E41 without translating the speech “Oh”. Furthermore, the self-terminal device 10-1 outputs the counterpart turn sound effect to the user E in a section E42 after the section E41 while the user J makes the utterance in the section J41. Furthermore, in the self-terminal device 10-1, the non-language utterance “hmm” in the utterance “rather than 8 o'clock, hmm, how about 10 o'clock?” is detected and recorded. Since the position of the non-language utterance “hmm” in the counterpart utterance text is between “rather than 8 o'clock” and “how about 10 o'clock” having a modification relationship, the position of “hmm” is at a word boundary with modification. Therefore, in the self-terminal device 10-1, “hmm” which is a speech of the non-language utterance directly overlaps with “How about 10 o'clock instead of 8 o'clock?” (section E44) which is a translation result for the language utterance “Rather than 8 o'clock, how about 10 o'clock?” (section E45), and is output without being translated.

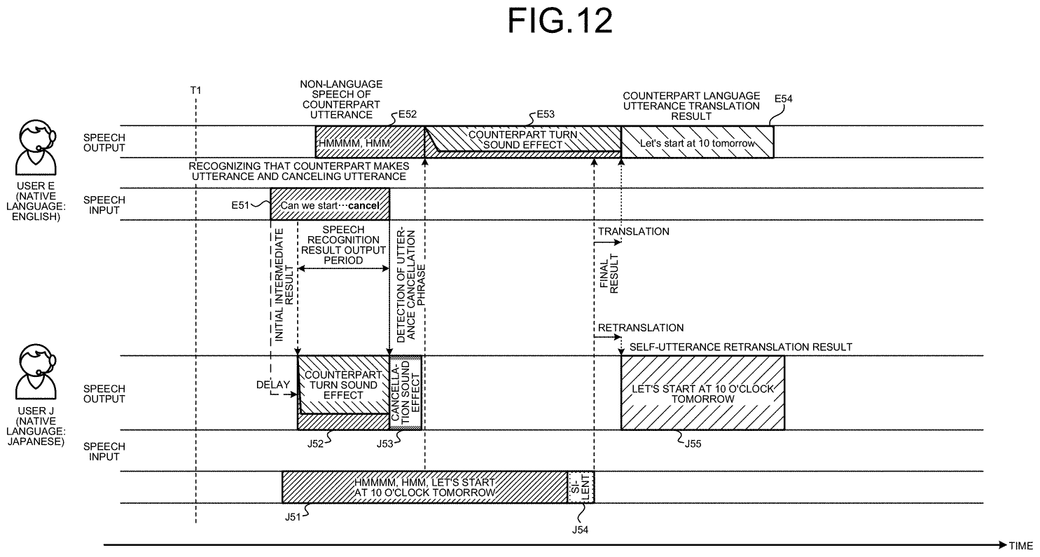

### Operation Example 5 (FIG. 12)

In FIG. 12, since an operation up to the time T1 is the same as Operation Example 1 (FIG. 8), a description thereof will be omitted.

In FIG. 12, the user J started uttering, “Hmmmm, Hmm, let's start at 10 o'clock tomorrow” in a section J51 almost at the same time as the user E started uttering, “Can we start . . . ” in a section E51.

The utterance “Hmmmm, Hmm, let's start at 10 o'clock tomorrow” made by the user J in the section J51 is translated from Japanese into English by the counterpart terminal device 10-2 after a silent section J54 and then further retranslated into Japanese, and a Japanese speech “Let's start at 10 o'clock tomorrow” is output to the user J in a section J55.

Furthermore, the self-terminal device 10-1 that has received the utterance of the user J, “Hmmmm, Hmm, let's start at 10 o'clock tomorrow” outputs the speech “Hmmmm, Hmm” in the non-language section in the utterance “Hmmmm, Hmm, let's start at 10 o'clock tomorrow” as it is in a section E52 without translating “Hmmmm, Hmm”. Furthermore, the self-terminal device 10-1 outputs the counterpart turn sound effect to the user E in a section E53 after the section E52 while the user J makes the utterance in the section J51. Furthermore, the self-terminal device 10-1 translates the speech “let's start at o'clock tomorrow” in the language section in the utterance “Hmmmm, Hmm, let's start at 10 o'clock tomorrow”, and outputs a speech “Let's start at 10 tomorrow” to the user E in a section E54.

Meanwhile, since the user E started to hear the non-language utterance of the user J, “Hmmmm”, immediately after starting to utter “Can we start . . . ” in the section E51, the user E utters a predetermined utterance cancellation phrase “cancel” in order to avoid utterance collision.

In the counterpart terminal device 10-2, since the utterance cancellation phrase “cancel” has been detected in the intermediate counterpart utterance text result, the counterpart turn sound effect output in a section J52 is stopped at a time point when the utterance cancellation phrase is detected, and the cancellation sound effect is output in a section J53 immediately after the counterpart turn sound effect is stopped.

Since the user J has heard the cancellation sound effect after the counterpart turn sound effect during the utterance “Hmmmm, Hmm” in the section J51, the user J determines that no utterance collision with the user E has occurred and utters “let's start tomorrow at 10 o'clock” after “Hmmmm, Hmm”.

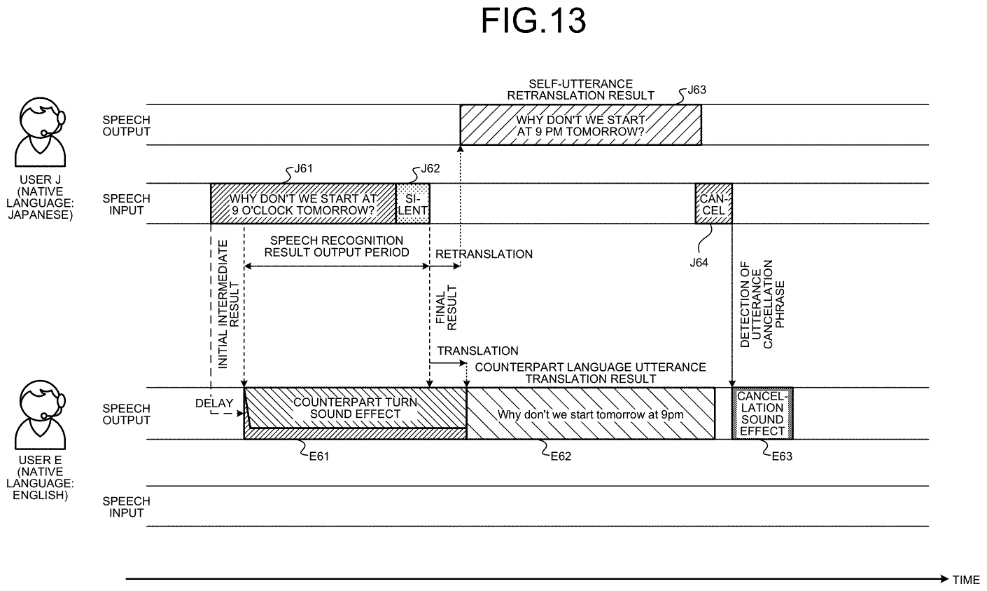

### Operation Example 6 (FIG. 13)

In FIG. 13, an utterance “Why don't we start at 9 o'clock tomorrow?” made by the user J in a section J61 is translated from Japanese into English by the counterpart terminal device 10-2 after a silent section J62, and then further retranslated into Japanese, and a Japanese speech “Why don't we start at 9 pm tomorrow?” is output to the user J in a section J63.

Furthermore, the self-terminal device 10-1 outputs the counterpart turn sound effect to the user E in a section E61 while the user J makes the utterance in the section J61. Furthermore, the utterance “Why don't we start at 9 o'clock tomorrow?” made by the user J in the section J61 is translated by the self-terminal device 10-1, and the speech “Why don't we start tomorrow at 9 pm” is output to the user E in the section E62.

Meanwhile, in the section J61, the user J utters “Why don't we start at 9 o'clock tomorrow?” with the intention of the start at 9 “am”, whereas in the section J63, the user J hears “Why don't we start at 9 pm tomorrow?”, and thus, the user J notices that, contrary to his/her intention, the user E is told to start at 9 “pm”. Therefore, in order to cancel the utterance of user J, the user J utters a predetermined utterance cancellation phrase “cancel” in a section J64.

Since the utterance cancellation phrase “cancel” has been detected, the self-terminal device 10-1 outputs the cancellation sound effect in a section E63. Since the user E hears the cancellation effect in the section E63 immediately after hearing the speech “Why don't we start tomorrow at 9 pm” in the section E62, the user E can know that the user J does not have the intention to start at 9 “pm”.

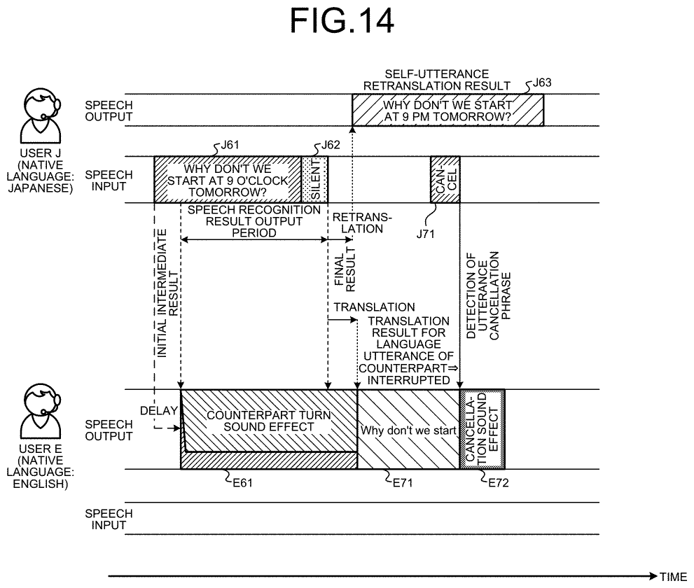

### Operation Example 7 (FIG. 14)

In FIG. 14, since operations in sections J61, J62, and E61 are the same as those in FIG. 13, a description thereof will be omitted.

In the section J61, the user J utters “Why don't we start at 9 o'clock tomorrow?” with the intention of the start at 9 “am”, whereas in the section J63, the user J hears “9 pm tomorrow”. Therefore, the user J notices that, contrary to his/her intention, the user E is told to start at 9 “pm” when the user J hears “9 pm tomorrow”. Therefore, in order to cancel the utterance of the user J, the user J utters a predetermined utterance cancellation phrase “cancel” in a section J71 when the user J hears “9 pm tomorrow”.

In the self-terminal device 10-1, since the utterance cancellation phrase “cancel” has been detected while a translation result for the utterance of the user J, “Why don't we start at 9 o'clock tomorrow?”, made in the section J61 is being output in a section E71, the speech output for the translation result in the section E71 is interrupted, and then the cancellation sound effect is output in a section E72. Since the user E hears the cancellation sound effect immediately after hearing “Why don't we start”, the user E can know at an early stage that the user J has canceled the utterance.

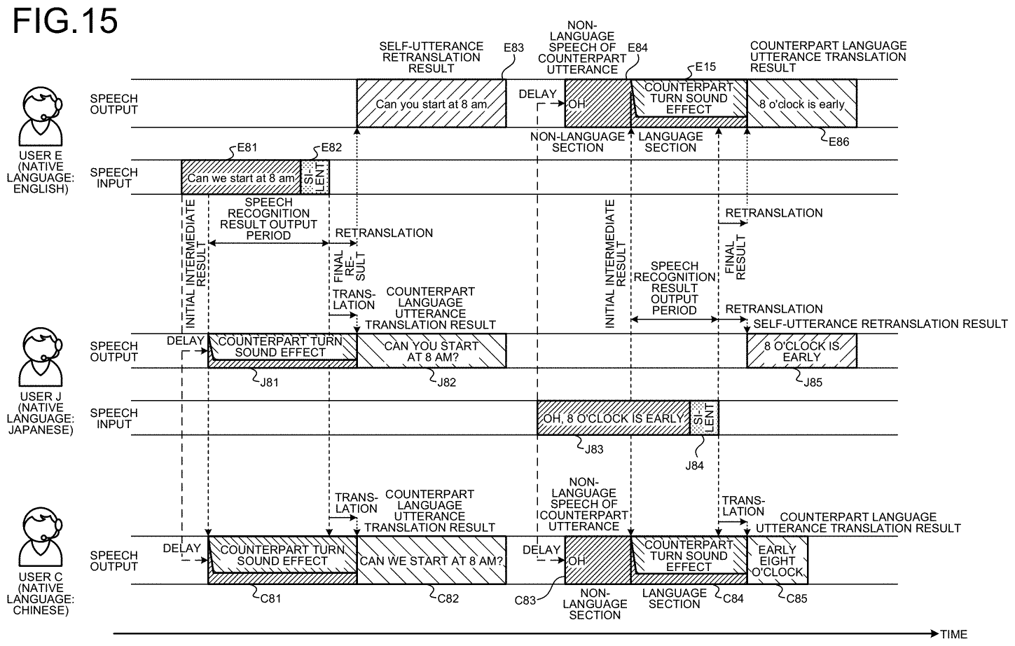

### Operation Example 8 (FIG. 15)

In Operation Example 8, a user C is a counterpart user who uses a counterpart terminal device 10-3. A native language of the user C is Chinese. The counterpart terminal device 10-3 has the same configuration as the self-terminal device 10-1 and the counterpart terminal device 10-2.

In FIG. 15, an utterance “Can we start at 8 am?” made by the user E in a section E81 is translated from English into Japanese by the self-terminal device 10-1 after a silent section E82, and then further retranslated into English, and a speech “Can you start at 8 am?” is output to the user E in a section E83.

Furthermore, while the user E makes the utterance in the section E81, the counterpart terminal device 10-2 outputs the counterpart turn sound effect to the user J in a section J81. Furthermore, the utterance “Can we start at 8 am?” made by the user E in the section E81 is translated by the counterpart terminal device 10-2, and a Japanese speech “Can you start at 8 am?” is output to the user J in a section J82.

Similarly, while the user E makes the utterance in the section E81, the counterpart terminal device 10-3 outputs the counterpart turn sound effect to the user C in a section C81. Furthermore, the utterance “Can we start at 8 am?” made by the user E in the section E81 is translated by the counterpart terminal device 10-3, and a translation result in Chinese for “Can we start at 8 am?” is output to the user C in a section C82.

Furthermore, an utterance “Oh, 8 o'clock is early” made by the user J in a section J83 is translated from Japanese into English by the counterpart terminal device 10-2 after a silent section J84, and then further retranslated into Japanese, and a Japanese speech “8 o'clock is early” is output to the user J in a section J85.

Furthermore, the self-terminal device 10-1 that has received the utterance of the user J, “Oh, 8 o'clock is early” outputs the speech “Oh” in the non-language section in the utterance “Oh, 8 o'clock is early” as it is in the section E84 without translating the speech “Oh”. Furthermore, the self-terminal device 10-1 outputs the counterpart turn sound effect to the user E in a section E85 after the section E84 while the user J makes the utterance in the section J83. Furthermore, the self-terminal device 10-1 translates the speech “8 o'clock is early” in the language section in the utterance “Oh, 8 o'clock is early” and outputs a speech “8 o'clock is early” to the user E in a section E86.

Similarly, the counterpart terminal device 10-3 that has received the utterance of the user J, “Oh, 8 o'clock is early” outputs the speech “Oh” in the non-language section in the utterance “Oh, 8 o'clock is early” as it is in a section C83 without translating the speech “Oh”. Furthermore, the counterpart terminal device 10-3 outputs the counterpart turn sound effect to the user C in a section C84 after the section C83 while the user J makes the utterance in the section J83. Furthermore, the counterpart terminal device 10-3 translates the speech “8 o'clock is early” in the language section in the utterance “Oh, 8 o'clock is early”, and outputs a Chinese speech “early eight o'clock” to the user C in a section C85.

The first embodiment has been described above.

### Second Embodiment

<Modification>

Instead of the self-utterance speech retranslated into the native language of the self-user, a speech obtained by translating the self-utterance text into the native language of the conversation counterpart, or a speech obtained by directly synthesizing the self-utterance text without translating the self-utterance text may be output.

The type of the counterpart turn sound effect may be different between when an utterance starts, when an utterance is being made, and when an utterance ends.

In the non-language section, instead of the raw voice of the conversation counterpart, a sound source prepared in advance or a voice of which intonation or rhythm is close to that of the voice of the conversation counterpart among voices generated using the TTS may be output.

A sound source corresponding to agreement, a question, or the like may be prepared in advance, and a sound source close to an intonation pattern of the non-language section may be output.

A sound source corresponding to a gesture or a facial expression of the conversation counterpart may be output using image recognition.

Instead of utterance cancellation by a predetermined cancellation phrase, an utterance may be canceled by detecting a predetermined gesture (for example, head shake or the like) using image recognition or an acceleration sensor.

Instead of outputting the cancellation sound effect, a wording indicating that the utterance has been canceled (which may hereinafter be referred to as a “cancellation wording”) may be output by voice. Furthermore, the cancellation wording may be changed according to the state of the speech output for the translation result for the utterance. For example, when the utterance is canceled before the translation result for the utterance is output by voice, a speech “canceled” may be output. When the utterance is canceled while the translation result for the utterance is being output by voice, a speech “This utterance has been canceled” may be output. When the utterance is canceled after the translation result for the utterance is completed, a speech “The previous utterance has been canceled” may be output.

Instead of canceling the utterance by a predetermined utterance cancellation phrase, when at least one of the following Conditions A, B, and C is satisfied, an inquiry such as “Cancel?” or “Send?” may be made to the user before canceling the utterance. In a case where Condition C is satisfied, it is preferable to inquire whether or not the previous utterance has been canceled.

(Condition A) It has been detected that the language section overlaps with that of the conversation partner.

(Condition B) It is determined that the utterance is not grammatically completed, for example, the utterance ends with a postpositional particle.

(Condition C) The content of the current utterance is similar to the content of the previous utterance. The determination as to whether the utterance contents are similar may be made based on the degree of coincidence of words in the utterance contents or the degree of coincidence of intent/entity by natural language understanding (NLU).

The second embodiment has been described above.

### Third Embodiment

All or part of each processing in the control unit 11 in the above description may be implemented by causing the control unit 11 to execute a program corresponding to each processing. For example, a program corresponding to each processing in the control unit 11 in the above description may be stored in the storage unit 12, and the program may be read from the storage unit 12 and executed by the control unit 11. Furthermore, the program may be stored in a program server connected to the terminal device 10 via an arbitrary network and downloaded from the program server to the terminal device 10 to be executed, or may be stored in a recording medium readable by the terminal device 10 and read from the recording medium to be executed. The recording medium readable by the terminal device 10 includes, for example, a portable storage medium such as a memory card, a USB memory, an SD card, a flexible disk, a magneto-optical disk, a CD-ROM, a DVD, and a Blu-ray (registered trademark) disk.

In addition, the program is a data processing method described in an arbitrary language or by an arbitrary description method, and may be in any format such as a source code or a binary code. In addition, the program is not necessarily limited to a single program, and includes a program configured in a distributed manner as a plurality of modules or a plurality of libraries, and a program that achieves a function thereof in cooperation with a separate program represented by an OS.

The third embodiment has been described above.

### Effects of Disclosed Technology

As described above, the information processing device of the present disclosure (the terminal device 10 according to the embodiment) includes the communication unit (the communication unit 15 according to the embodiment) and the control unit (the control unit 11 according to the embodiment). The communication unit receives language information (the counterpart utterance text in the counterpart language section according to the embodiment) in a conversation with a communication counterpart and non-language information (the counterpart utterance speech in the counterpart non-language section according to the embodiment) in the conversation with the communication counterpart. The control unit outputs the language information after performing language translation, and outputs the non-language information without performing language translation.

In this way, since the non-language information is output without being subjected to language translation together with a result of the language translation of the language information, it is possible to transfer nuances by the non-language information such as a quick response and fillers from the speaker side to the listener side. As a result, smooth remote communication can be made between different languages.

Further, the control unit outputs the non-language information before outputting the result of the language translation of the language information.

In this way, the non-language information such as a quick response and fillers can be transmitted from the speaker side to the listener side with a low latency, so that the listener side can sense the intention and attitude of the speaker side in real time. Therefore, the conversation turn-taking can be more accurately and more quickly made. Furthermore, for example, in a case where voice chatting between different languages during a game is performed using automatic translation, a shout from the speaker side or the like is immediately transferred to the listener side, so that the listener side can take an action in real time in response to the shout from the speaker side or the like.

Furthermore, the control unit generates a sound effect indicating that the communication counterpart is making an utterance (the counterpart turn sound effect according to the embodiment).

This makes it possible to clearly grasp that the current turn in the conversation is on the communication counterpart side.

Furthermore, the control unit mutes or ducks the uttered speech of the communication counterpart.

As a result, for example, in a case where the language spoken by the speaker is an incomprehensible language, or the like, it is possible to alleviate the mental pain of the listener side caused by hearing the uttered speech of the speaker. Furthermore, for example, it is possible to satisfy a demand of the speaker who does not want the listener side to hear his/her raw voice.

Furthermore, the information processing device includes the speech input unit (the speech input unit 13 according to the embodiment) through which a speech is input. The control generates information with which the content of the input speech is checkable. For example, the control unit generates the information with which the content of the input speech is checkable (the translated self-utterance text according to the embodiment) by retranslating, into the native language of the user of the information processing device, a result of translation of a speech recognition result for the input speech into the native language of the communication counterpart.

In this way, the speaker can grasp at an early stage whether or not there is an error in the information transmitted from the speaker side to the listener side.

Furthermore, the control unit cancels information (the intermediate self-utterance text result according to the embodiment) generated from the input speech according to a predetermined phrase (the predetermined utterance cancellation phrase according to the embodiment).

In this way, for example, when there is an error in the information transmitted to the listener side, the speaker side can cancel the erroneous information at an early stage. Furthermore, for example, on the speaker side, it is possible to avoid utterance collision with the listener side at an early stage.

The effects described in the present specification are merely examples and are not limited, and other effects may be provided.

Furthermore, the disclosed technology can be applied not only to a system of “person-system-network-system-person” as described above but also to a system in which people wearing earphones implementing the disclosed technology communicate with each other in the real world.

Furthermore, the disclosed technology can also adopt the following configurations.

(1)

An information processing device comprising:
a communication unit that receives language information in a conversation with a communication counterpart and non-language information in the conversation; and
a control unit that outputs the language information after performing language translation and outputs the non-language information without performing language translation.

(2)

The information processing device according to (1), wherein
the control unit outputs the non-language information before outputting a result of the language translation of the language information.

(3)

The information processing device according to (1) or (2), wherein
the control unit generates a sound effect indicating that the communication counterpart is making an utterance.

(4)

The information processing device according to anyone of (1) to (3), wherein
the control unit mutes or ducks an uttered speech of the communication counterpart.

(5)

The information processing device according to anyone of (1) to (4), further comprising
a speech input unit through which a speech is input, wherein
the control unit generates information with which a content of the input speech is checkable.

(6)

The information processing device according to (5), wherein
the control unit generates the information with which the content of the input speech is checkable by retranslating, into a native language of a user of the information processing device, a result of translation of a speech recognition result for the input speech into a native language of the communication counterpart.

(7)

The information processing device according to anyone of (1) to (4), further comprising
a speech input unit through which a speech is input, wherein
the control unit cancels information generated from the input speech according to a predetermined phrase.

(8)

An information processing method comprising:
receiving language information in a conversation with a communication counterpart and non-language information in the conversation; and
outputting the language information after performing language translation and outputting the non-language information without performing language translation.

### REFERENCE SIGNS LIST

1 REMOTE COMMUNICATION SYSTEM
10-1 SELF-TERMINAL DEVICE
10-2 COUNTERPART TERMINAL DEVICE
11 CONTROL UNIT
12 STORAGE UNIT
13 SPEECH INPUT UNIT
14 SPEECH OUTPUT UNIT
15 COMMUNICATION UNIT
31 SELF-UTTERANCE DETECTION UNIT
32 SPEECH RECOGNITION UNIT
33 SELF-UTTERANCE CONTROL UNIT
34 TRANSLATION PROCESSING UNIT
35 SPEECH SYNTHESIS UNIT
36 DELAY PROCESSING UNIT
37 NATURAL LANGUAGE PROCESSING UNIT
38 COUNTERPART UTTERANCE DETECTION UNIT
39 COUNTERPART UTTERANCE CONTROL UNIT
41 SOUND EFFECT GENERATION UNIT
42 MUTING/DUCKING UNIT
43 COUNTERPART UTTERANCE SYNTHESIS UNIT

1. An information processing device comprising:
a communication unit that receives language information in a conversation with a communication counterpart and non-language information in the conversation; and
a control unit that outputs the language information after performing language translation and outputs the non-language information without performing language translation.

2. The information processing device according to claim 1, wherein
the control unit outputs the non-language information before outputting a result of the language translation of the language information.

3. The information processing device according to claim 1, wherein
the control unit generates a sound effect indicating that the communication counterpart is making an utterance.

4. The information processing device according to claim 1, wherein
the control unit mutes or ducks an uttered speech of the communication counterpart.

5. The information processing device according to claim 1, further comprising
a speech input unit through which a speech is input, wherein
the control unit generates information with which a content of the input speech is checkable.

6. The information processing device according to claim 5, wherein
the control unit generates the information with which the content of the input speech is checkable by retranslating, into a native language of a user of the information processing device, a result of translation of a speech recognition result for the input speech into a native language of the communication counterpart.

7. The information processing device according to claim 1, further comprising
a speech input unit through which a speech is input, wherein
the control unit cancels information generated from the input speech according to a predetermined phrase.

8. An information processing method comprising:
receiving language information in a conversation with a communication counterpart and non-language information in the conversation; and
outputting the language information after performing language translation and outputting the non-language information without performing language translation.
